(19) United States
(12) Patent Application Publication
(10) Pub. No.: US 2006/0085210 A1
(43) Pub. Date: Apr. 20, 2006

(54) System and method for facilitating like kind exchanges

(76) Inventor: Michael Owens, Santa Ana, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/969,299

(22) Filed: Oct. 19, 2004

(51) Int. Cl. G06Q 99/00

(52) U.S. Cl. 705/1

(57) ABSTRACT

An interactive computer system, preferably hosted on the Internet, has interfaces that obtain entity-specific information regarding a property owner, obtain property-specific information of the property to be exchanged in a 1031 exchange, and establish a contract that engages the services of a facilitator to handle the exchange. An inducement to enter into the contract can advantageously be included, as for example, an automated valuation model to estimate a value of the property.

### BACKGROUND

Owners of appreciated real and other property generally owe taxes upon sale of the property. Title 26, Section 1031 of the Internal Revenue Code (hereinafter “1031”) alleviates the burden to some extent by deferring taxes on exchanges that meet certain requirements.

Section 1031 has been part of the tax code since 1929, but for most of that time period the provision was little used due to a perceived requirement that the exchanges needed to be simultaneous. In 1979, the U.S. Court of Appeals for the Ninth Circuit reinterpreted section 1031, holding that property owners could transfer the relinquished property during a specified window prior to transferring the replacement property. Starker v. United States, 602 F.2d 1341 (9th Cir. 1979).

Congress codified the Starker case holdings in 1984, and in 1991, the Internal Revenue Service (IRS) issued Deferred Exchange Regulations that provided clarification and guidance on performing deferred exchanges under Section 1031. Current regulations provide for the following:
The new property (the “replacement property”) must have both value and debt that are equal to or greater than the value and debt of property being sold (the “relinquished property”);
The owner of the exchanged property (the “exchanger”) has 45 days to identify replacement property choosing either the three-property or the 200% rule, and a total of 180 days to close on the replacement properties; and
The exchanger cannot exercise control, either direct or indirect, over the proceeds of the sale of the first property.

The IRS regulations also created “safe harbors” that taxpayers could rely on to ensure compliance with Section 1031. One of these safe harbors is the use of a “qualified intermediary”—an arm's length third party that acquires the relinquished property from the taxpayer, transfers the relinquished property, acquires the replacement property from another entity, and transfers the replacement property to the taxpayer. The qualified intermediary handles all of the funds, and the taxpayer cannot have actual or constructive receipt of the proceeds from the transfer of the relinquished property until the transfer of the replacement property. Sometimes there is also a facilitator, who brings together the buyer, seller, real estate broker, qualified intermediary, tax attorneys, and any other necessary components to assist in completing the transaction. The facilitator may or may not also provide some of these other functions.

The new regulations created a boom in like kind exchanges. That trend was even further boosted in recent years by popularity of public access computer networks such as the Internet. Currently, there are numerous sites through which property owners can receive guidance in completing the 1031 exchange process. For example, www.apiexchange.com, focuses on the importance of selecting a qualified intermediary, which of course is written in a manner that emphasizes their own qualifications. Another site, www.1031ea.com, focuses on the experience of their individual agents. Still another site, www.for1031.com, provides useful information, while scrolling images of properties for exchange.

Significantly, these and all other sites of which the present inventors are currently aware are merely marketing ramps. The main purpose of the sites appear to be to encourage a property owner to call, email, or otherwise contact an agent who will then try to sell their own services as a qualified intermediary. One cannot contract to engage a qualified intermediary directly from the web site.

In the patent literature, U.S. Pat. No. 6,292,788 to Roberts et al. (September 2001) describes a system by which real estate can be divided into a plurality of tenant-in-common deeds, in such a manner that they are eligible for tax-deferred treatment under § 1031. There is also disclosure that the system can be at least partially implemented using databases accessed across the Internet, but there is no teaching at all regarding contracting of the qualified intermediaries or facilitators. Indeed, there is no disclosure at all with respect to activities of facilitators in the application. The Roberts et al. patent, as well as all other patents and applications identified herein, are incorporated herein by reference in their entirety.

US 2002/0035533 to Mache et al. (published March 2002) does teach implementation of a distributed, Internet-based interface for facilitating like kind exchanges, such as § 1031 exchanges. The focus, however, is on exchanges of equipment as opposed to real property. As such, there is considerable disclosure regarding identification of the property according to General Asset Class and Product Class. Here, there is considerable teaching with respect to the functions of a qualified intermediary, but no teaching at all with respect to contracting with a facilitator. Indeed, the “invention” comprises replacement of the broker by a network-based platform, with the application expressly distinguishing between the broker and the qualified intermediary.

US 2003/0120518 to Galley (published June 2003) describes methods of insuring § 1031 exchanges. The application discusses the possibility that a qualified intermediary could provide the insurance to the property owner, but once again is substantially silent as to Internet implementation, and says nothing about contracting with a facilitator.

US 2002/0082961 to Abraham et al (published June 2002) teaches a computer system programmed to transact a § 1031 exchange. The application provides considerable detail regarding contemplated interfaces, and expressly contemplates that the administrator of the system could be the qualified intermediary (para. no. 71). But nowhere does there appear to be any contemplation that the contract by which the property owner engages the qualified intermediary would itself be entered into using the computer system. Silence on that point is entirely consistent with the known web sites discussed above, which act mainly as a marketing tool to generate leads, and provide services only after the qualified intermediary is engaged by the property owner.

The closest that the prior art comes to using the Internet to actually contract the services of a qualified intermediary or facilitator appears to be a web site operated on behalf of Realty Exchangers, Inc. in Vancouver, Wash. Their site, at www.exchangers.com not only provides step by step instructions on executing a 1031 exchange, but also has an interface for a property owner to input specific information about his property. That interface provides a wealth of information that is needed to prepare the engagement agreement, but significantly still doesn't provide the needed disclaimers, and all the tenns that need to be included in the contract between the property owner and either a qualified intermediary or a facilitator. The site apparently still uses the information as a lead generator, and relies upon an old fashioned call or other communication between a sales agent and the property owner to close the deal.

Another currently available website is http://www.allstates1031.com/. That site, apparently operated by All States 1031 Exchange Facilitator, LLC, provides information to potential customers, who then contact the company. The web site acts as a lead generation tool, rather than providing a mechanism for the customer and company to enter into an agreement.

Thus, there is still a need for an interactive computer system that renders a preliminary search, valuation, or other service as a step in engaging the property owner in a contract with a facilitator to exchange the first property for a second property of like kind.

### SUMMARY OF THE INVENTION

The present invention provides apparatus, systems and methods in which an interactive computer system includes interfaces in which the property owner (a) provides entity-specific information regarding itself/himself/herself, (b) provides property-specific information regarding a first property owned by the property owner, and (c) contracts with a facilitator to assist the property owner in exchanging a first property for a second property of like kind.

The contemplated systems and methods are thought to be especially useful in circumstances where the property owner gains a tax-advantage exchange, as for example under IRS rule 1031.

The contemplated systems and methods are also thought to be especially useful in the field of real estate, where the property owner contracts for a preliminary search, valuation, or other service as a step in engaging the facilitator to facilitate the property exchange. In preferred embodiments the property owner contracts to pay a fee for such service, the service is performed, and the property owner can then either (a) pay the fee, or (b) agree to have the fee waived by engaging the services of the facilitator.

In other aspects of preferred embodiments, display identifies to the property owner, subsequent to the property owner contracting to pay for the service, a set of at least three specific replacement properties from which the second property can be selected to effect a tax advantaged exchange for the property owner. Those replacement properties can be shown to the property owner before or after the owner contracts to engage the facilitator.

In other aspects of the invention, a third party can make money by hosting a set of computer programs that provide the interfaces and displays discussed above, and/or by providing a link to a site that accomplishes the same.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a flow chart of a user interacting with a web site through which a user engages a company to act as facilitator for a 1031 exchange.

FIG. 2 is a web-based interface for obtaining entity-specific information regarding a property owner.

FIG. 3 is a web-based interface for obtaining property-specific information.

FIG. 4 is a web-based interface for purchasing a valuation service.

FIG. 5 is a web-based interface for selection of either immediate payment for the service, or waiver of the service fee by engaging with a facilitator.

FIG. 6 is a web-based display of properties that qualify for a 1031 exchange.

### DETAILED DESCRIPTION

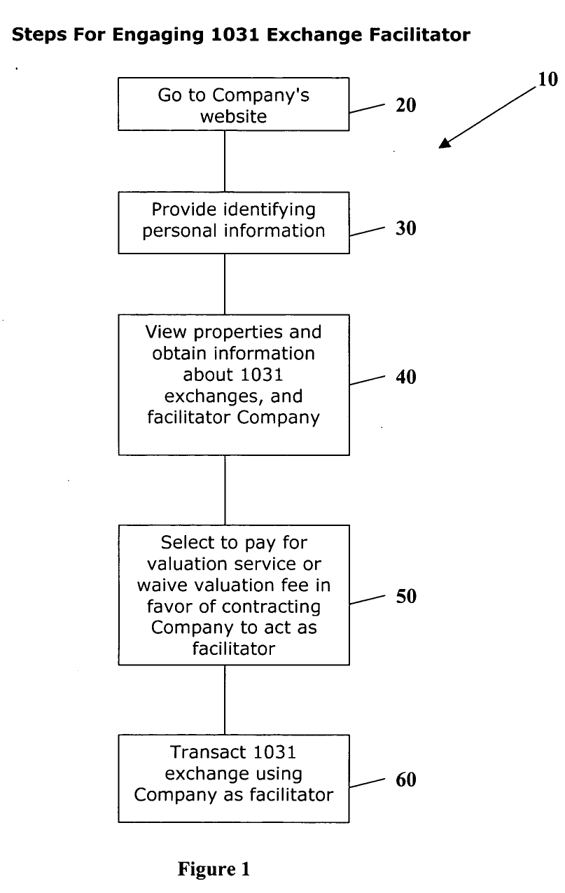

In FIG. 1, a flowchart 10 has five main steps, step 20—going to the website of the facilitator; step 30—the user providing identifying information; step 40—the user viewing properties and receiving additional information regarding the services and charges of the facilitator; step 50—the user deciding between paying for the valuation or other service on the one hand, and on the other hand having the fee waived in favor of the user engaging the facilitator; and step 60—the user eventually transacting a 1031 exchange using the Company as the facilitator.

What is referred to as the Company in FIG. 1 is actually the facilitator of the 1031 exchange. The term Company is a euphemism, and should be interpreted as including all manner of corporations, partnerships, individual proprietorships, DBAs, and the like, which are acting as a facilitator. The Company need not have written the web site or be hosting the web site. Indeed, those functions would very likely have been provided by one or more outside contractors. The steps shown would usually be executed in the order shown. It should be appreciated that although steps 20-50 would typically occur during a relatively short time frame of less than 15 minutes, the final step of transacting a 1031 exchange may occur days or weeks later, so long as the 1031 legal requirements are satisfied.

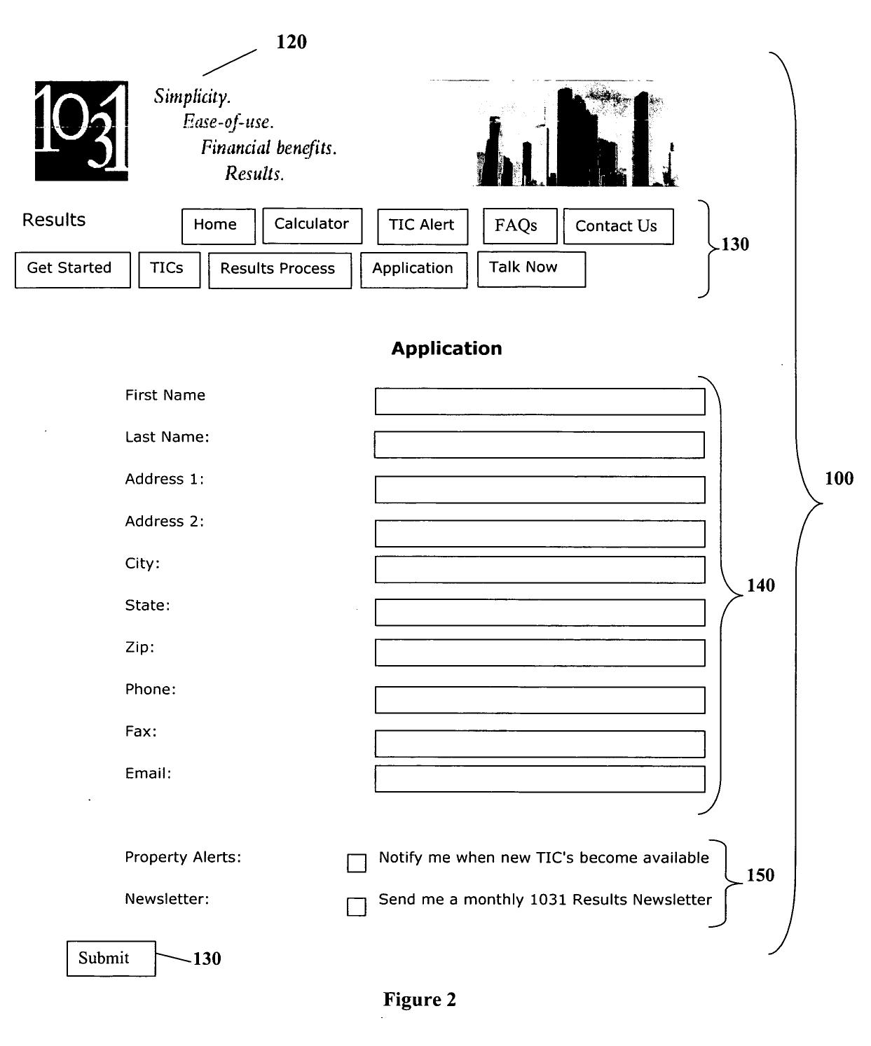

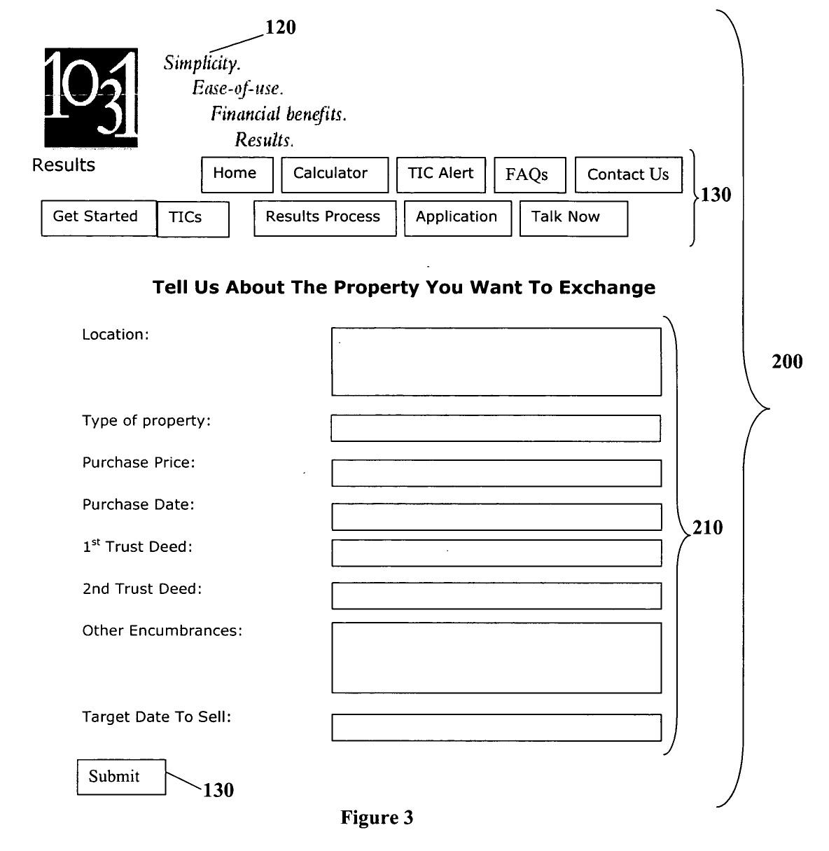

In FIG. 2 a web page 100 provides fields 140 or other devices for a user to provide his/her personal information. The information is needed or helpful in preparing the contract through which the user signs up to engage the Company as its facilitator. This information is relatively straightforward, although more or less information could alternatively be secured from the user. It will be appreciated by those skilled in the art that the specific format of the web page is irrelevant to the inventive concepts. FIG. 2, as well as FIGS. 3-6 are all simply exemplary.

In this example, web page 100 has an advertising logo 120, and navigation buttons 130. There can also be various other fields 140 and buttons 150 that provide other services, or further engage a user to continue a relationship with the web site and/or the Company. The advertising logo 120, and navigation buttons 130 carry through to FIGS. 3-6.

In FIG. 3 a web page 200 provides fields 210 or other devices for a user to provide information regarding the property that he/she want to exchange. The information is needed or helpful in preparing the valuation, and also serves to further entice the user to continue further into the website, and engage the services of the facilitator.

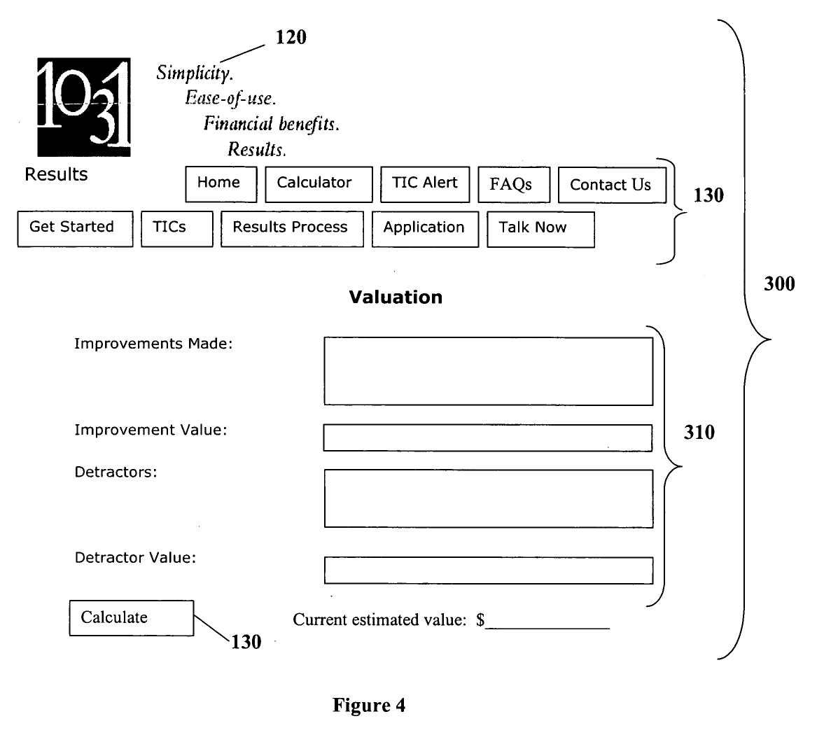

In FIG. 4 a web page 300 provides fields 310 or other devices for a user to provide information that can be used by the automatic valuation program.

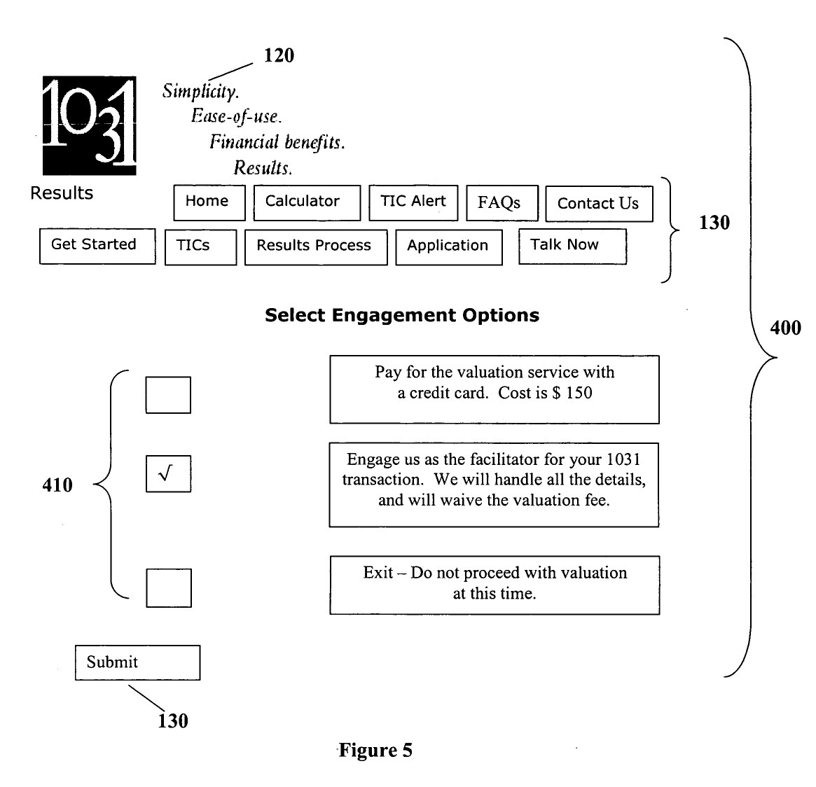

In FIG. 5 a web page 400 provides a set of three radio buttons 410 with which the user selects one of three options: (a) “Pay for the valuation service with a credit card. Cost is $150”; (b) “Engage us as the facilitator for your 1031 transaction. We will handle all the details, and will waive the valuation fee”; and (c) Exit—Do not proceed with valuation at this time. The radio buttons 410 force the user to choose only one option. Of course, the specific options, and certainly the language to describe the options, are exemplary only.

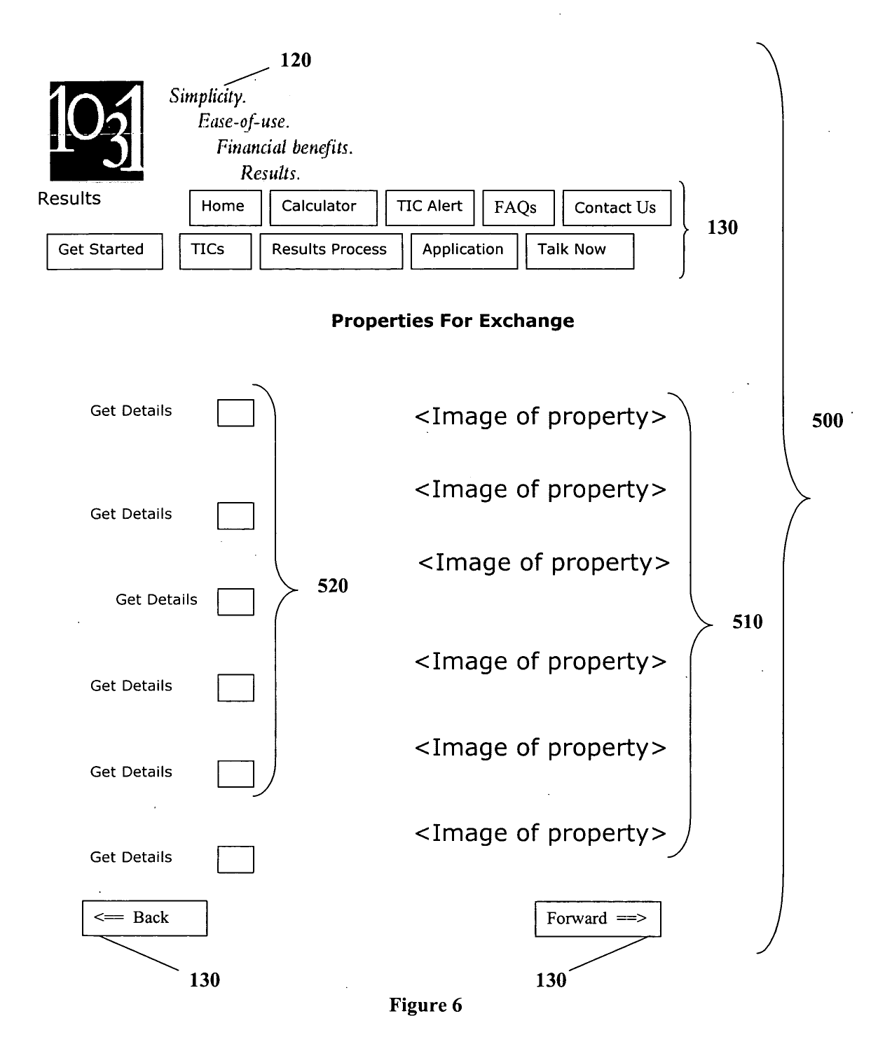

In FIG. 6, a web page 500 provides a listing 510 of properties available for exchange. The properties are advantageously listed using only a picture or basic information, and buttons 520 are preferably used to obtain further details. The listing can span multiple pages, and in some cases can be sorted or filtered in some manner by the user.

Thus, specific embodiments and applications of computer systems for facilitating implementation of § 1031 exchanges have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An interactive computer system, comprising:
a first electronic interface that obtains entity-specific information regarding a property owner;
a second electronic interface that obtains property-specific information regarding a first property owned by the property owner; and
a third electronic interface through which the property owner enters into a contract to engage a facilitator to exchange the first property for a second property of like kind.

2. The system of claim 1, wherein the first property comprises real estate.

3. The system of claim 2, further comprising a fourth electronic interface through which the property owner, prior to the property owner contracting to engage the facilitator, contracts to pay a fee for a service.

4. The system of claim 3, wherein the service comprises utilizing an automated valuation model to estimate a value of the first property.

5. The system of claim 2, further comprising a fifth electronic interface through which the property owner arranges to make a payment for the service, and wherein the payment is transacted after the property owner contracts to engage the facilitator.

6. The system of claim 3, further comprising a display that identifies to the property owner, subsequent to the property owner contracting to pay for the service, a set of at least three specific replacement properties from which the second property can be selected to effect a tax advantaged exchange for the property owner.

7. The system of claim 2, further comprising a display that identifies to the property owner, prior to the property owner contracting to engage the facilitator, a set of at least three specific replacement properties from which the second property can be selected to effect a tax advantaged exchange for the property owner.

8. The system of claim 2, further comprising a display that provides to the property owner, prior to the property owner contracting to engage the facilitator, prior to the property owner contracting to engage the facilitator, any legally required disclosure relating to engagement of the facilitator by the property owner.

9. The system of claim 1, further comprising at least one additional electronic interface through which the property owner, prior to the property owner contracting to engage the facilitator, (a) contracts to pay a fee for a service; (b) is provided at three specific replacement properties from which the second property can be selected to effect a tax advantaged exchange for the property owner; (c) provides the property owner with any legally required disclosure relating to engagement of the facilitator by the property owner.

10. The system of claim 9 wherein all of the interfaces are accessible through a web page of a public package-switched network.

11. The system of claim 1, further comprising an electronic capital gains calculator interface that can be used by the property owner to estimate a tax savings by using a tax advantaged exchange rather than a sale to relinquish the first property.

12. The system of claim. 1, further comprising additional electronic interfaces through which the property owner contracts to use an automated valuation model to estimate a value of the first property, then contracts to engage the facilitator, and then arranges to pay for use of the automated valuation service.

13. A method of facilitating a like kind property exchange through a publicly accessible site of a computer network, comprising the following steps:
obtaining personal information on a property owner;
obtaining information about a property owned by the property owner;
providing a list of specific exchange properties that can be utilized by the property owner to execute a tax advantaged exchange of the property; and
providing an acceptance interface through which a facilitator can be contractually engaged to represent the property owner with respect to an exchange of the property for one of the exchange properties.

14. The method of claim 13, further comprising:
performing a service related to property for a fee; and
securing payment for the service after the property owner has contractually engaged the facilitator.

15. The method of claim 14, wherein the service comprises using an automated valuation model to estimate a value of the property.

16. The method of claim 14, further comprising discounting the fee upon the property owner completing the tax advantaged exchange of the property.

17. The method of claim 13, further comprising providing a property-choosing interface through which the property owner can choose at least three of the exchange properties to satisfy a tax code provision.

18. The method of claim 13, further comprising using a web page of the Internet as the publicly accessible site.

19. A method of making money, comprising hosting a set of computer programs that accomplishes the steps of claim 13.

20. A method of making money, providing a link to a site that accomplishes the steps of claim 13.
